(19) United States
(12) Patent Application Publication
(10) Pub. No.: US 2009/0017803 A1
(43) Pub. Date: Jan. 15, 2009

(54) SYSTEM AND METHOD FOR DYNAMIC DETERMINATION OF A COMMON MEETING POINT

(76) Inventors: David Clark Brillhart, Orlando, FL (US); Christopher James Dawson, Arlington, VA (US); Michael David Kendzierski, New York, NY (US); James Wesley Seaman, Falls Church, VA (US)

Correspondence Address: IBM CORP (YA);C/O YEE & ASSOCIATES PC, P.O. BOX 802333, DALLAS, TX, 75380, US

(21) Appl. No.: 11/775,070

(22) Filed: Jul. 9, 2007

(51) Int. Cl. H04Q 7/22

(52) U.S. Cl. 455/414.2; 455/457

(57) ABSTRACT

A method, computer program product, and a data processing system continuously tracks the potentially changing location of a plurality of global positioning system (GPS) enabled mobile devices such as a cellular phones or Personal Digital Assistant (PDA). Generated GPS location updates are used to determine the location and directional velocity of each monitored device. Unique and separate optimal navigation convergence routes are provided to each device. Convergence locations and ETA indicators are provided. A common destination for the devices based on the separate convergence routes is provided. The common destination can be user selected or automatically determined by the system. The system is capable of providing convergence route and common destination information even when users of the various GPS devices are unaware of their present location, the location of other consenting devices, or the location of the common destination.

### FIELD OF THE INVENTION

The present invention relates generally to an improved data processing system and in particular to a method and apparatus for processing data. Still more particularly, the present invention relates to a computer implemented method, apparatus, and computer usable program code for generating meeting points.

### DESCRIPTION OF THE RELATED ART

In today's highly mobile environment, people often find themselves in unfamiliar surroundings, and yet need to locate and meet with friends, colleagues, associates, and/or fixed locations. People attempt to pick meeting locations by telling each other where they are and by suggesting locations that are convenient for one or more of the parties. However, the chosen location may not be convenient for other persons who are also meeting at the chosen location.

Current global positioning system (GPS) enabled devices are capable of determining only the location of a fixed or static destination address when using satellite navigation. Various parties can pick a place. Each party is able to see how far away that party is from the selected place using mapping programs. The current GPS based navigation systems in a phone or other mobile device can tell where a user is for this purpose and how long it will take the user to get to the meeting point from a present location. However, current systems do not take into account actual travel times and potential delays, such as traffic conditions or how fast a person will actually drive or walk. Furthermore, no automatic routing is used.

### SUMMARY OF THE INVENTION

Systems and methods are provided for continually tracking the potentially changing location of a plurality of GPS enabled mobile devices such as cellular phones or Personal Digital Assistants (PDA). The system uses device generated GPS location updates to determine the location and velocity of each device. The system then provides a separate optimal navigation convergence route to each device for convergence at a common convergence location.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which the present invention may be implemented;

FIG. 2 is a block diagram of a data processing system that may be implemented as a server in accordance with a preferred embodiment of the present invention;

FIG. 3 is a diagram of a client in the form of a personal digital assistant (PDA) depicted in accordance with a preferred embodiment of the present invention;

FIG. 4 is a block diagram of a PDA depicted in accordance with a preferred embodiment of the present invention;

FIG. 5 is a diagram illustrating data flow through the various components and systems in accordance with a preferred embodiment of the present invention;

FIG. 6 is a diagram illustrating a plurality of mobile clients being dynamically directed to a destination convergence location in accordance with a preferred embodiment of the present invention;

FIG. 7 is a flowchart of the processing performed by the client GPS device depicted in accordance with a preferred embodiment of the present invention; and

FIG. 8 is a flowchart of the processing performed by the central data processing system depicted in accordance with a preferred embodiment of the present invention.

### DETAILED DESCRIPTION OF THE PREFERRED EMBODIMENT

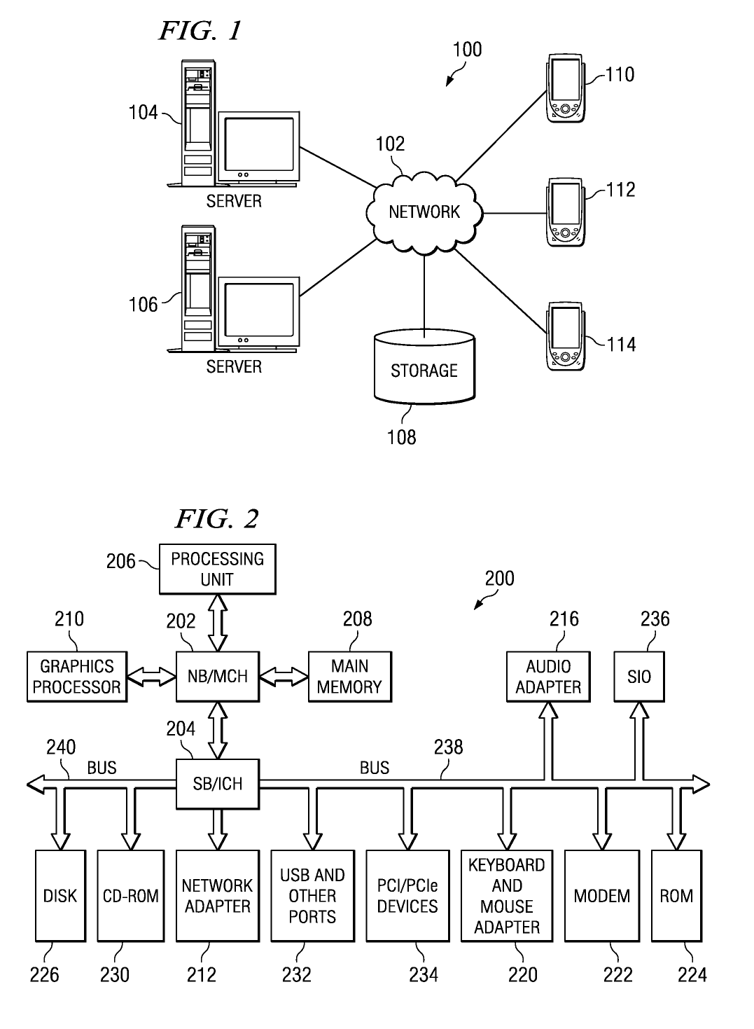

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal digital assistants, personal computers or network computers. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments. Referring to FIG. 2, a block diagram of a data processing system that may be implemented as a server, such as server 104 in FIG. 1, is depicted in accordance with a preferred embodiment of the present invention. Data processing system 200 is an example of a computer that may be used to analyze location and velocity vector information obtained from one or more of clients 110, 112, 114. More specifically, data processing system 200 receives location and velocity vector information from a plurality of GPS enabled mobile client devices and analyzes the location information from each client. Present velocity vector information is calculated from the received location information for each mobile client. Data processing system 200 determines location and navigational information, and then communicates this information to each mobile client. Location and navigational information includes the common convergence location, and optionally, a unique preferred navigation route specific to each mobile client.

In the depicted example, data processing system 200 employs a hub architecture including a north bridge and memory controller hub (NB/MCH) 202 and a south bridge and input/output (I/O) controller hub (SB/ICH) 204. Processing unit 206, main memory 208, and graphics processor 210 are coupled to north bridge and memory controller hub 202. Processing unit 206 may contain one or more processors and even may be implemented using one or more heterogeneous processor systems. Graphics processor 210 may be coupled to the NB/MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) and other ports 232, and PCI/PCIe devices 234 are coupled to south bridge and I/O controller hub 204 through bus 238, and hard disk drive (HDD) 226 and CD-ROM 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to south bridge and I/O controller hub 204.

An operating system runs on processing unit 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java™ programs or applications executing on data processing system 200. Java™ and all Java™-based trademarks are trademarks of Sun Microsystems, Inc. in the United States, other countries, or both.

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, clients 110, 112, 114 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course, the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

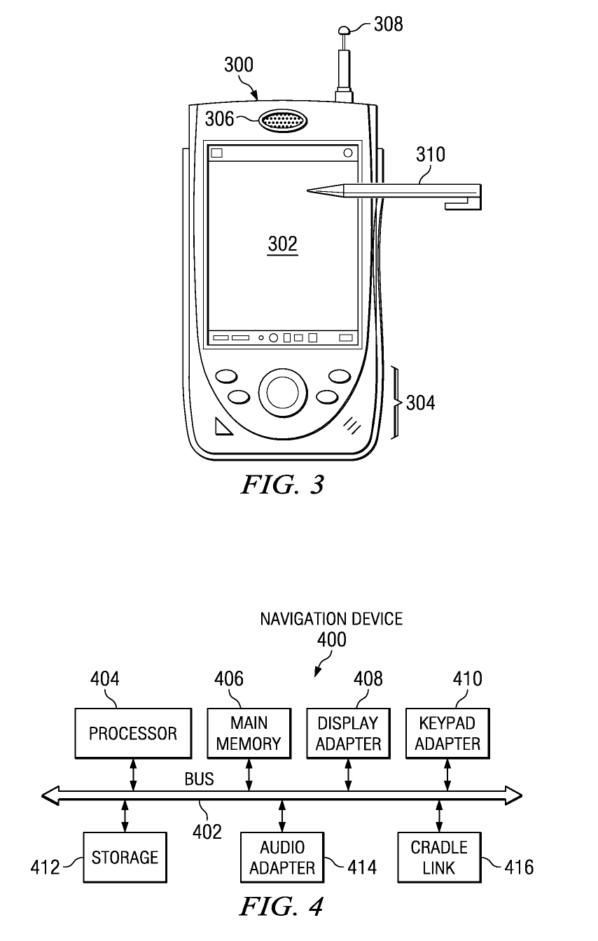

With reference now to FIG. 3, a diagram of a mobile client in the form of a personal digital assistant (PDA) is depicted in accordance with a preferred embodiment of the present invention. PDA 300 includes a display 302 for presenting textual and graphical information. Display 302 may be a known display device, such as a liquid crystal display (LCD) device. The display may be used to present a map or directions, calendar information, a telephone directory, or an electronic mail message. In these examples, screen 302 may receive user input using an input device such as, for example, stylus 310.

PDA 300 may also include keypad 304, speaker 306, and antenna 308. Keypad 304 may be used to receive user input in addition to using screen 302. Speaker 306 provides a mechanism for audio output, such as presentation of an audio file. Antenna 308 provides a mechanism used in establishing a wireless communications link between PDA 300 and a network, such as network 202 in FIG. 2.

PDA 300 also preferably includes a graphical user interface that may be implemented by means of systems software residing in computer readable media in operation within PDA 300.

Turning now to FIG. 4, a block diagram of a PDA is shown in accordance with a preferred embodiment of the present invention. PDA 400 is an example of a PDA, such as PDA 300 in FIG. 3, in which code or instructions implementing the processes of the present invention may be located. PDA 400 includes a bus 402 to which processor 404 and main memory 406 are connected. Display adapter 408, keypad adapter 410, storage 412, and audio adapter 414 also are connected to bus 402. Cradle link 416 provides a mechanism to connect PDA 400 to a cradle used in synchronizing data in PDA 400 with another data processing system. Further, display adapter 408 also includes a mechanism to receive user input from a stylus when a touch screen display is employed.

An operating system runs on processor 404 and is used to coordinate and provide control of various components within PDA 400 in FIG. 4. The operating system may be, for example, a commercially available operating system such as Windows CE, which is available from Microsoft Corporation. Instructions for the operating system and applications or programs are located on storage devices, such as storage 412, and may be loaded into main memory 406 for execution by processor 404.

Those of ordinary skill in the art will appreciate that the hardware in FIG. 4 may vary depending on the implementation. Other internal hardware or peripheral devices, such as flash ROM (or equivalent nonvolatile memory) or optical disk drives and the like, may be used in addition to or in place of the hardware depicted in FIG. 4.

PDA 400 is an example of a GPS enabled mobile client, such as client 108 in FIG. 1, that may be used for transmitting GPS location information to data processing system 200 in FIG. 2. PDA 400 may further be used for receiving a converge point from data processing system 200 in FIG. 2. Depending on the processing capabilities of PDA 400, it is also used to calculate or receive a unique convergence route.

More particularly, a process stored in PDA 400 receives GPS location information from a satellite navigation system. In response to a user input, the process communicates to the data processing system in FIG. 2 a consent request to be forwarded to at least one other GPS enabled mobile client. The consent request is then forwarded through the network to the other mobile clients for acceptance of the request. Consenting to the request allows a mobile client to receive location and navigational information regarding each of the other consenting mobile clients. Location and navigational information regarding other consenting mobile clients can then be continuously received, tracked, and updated by at least one of the PDA 400 and data processing system 200 in FIG. 2. Upon receiving an acceptance confirmation of the consent request from the other mobile client via the data processing system 200 in FIG. 2, PDA 400 communicates to the data processing system 200 in FIG. 2 current GPS location information of PDA 400.

By continuously communicating real-time location updates from PDA 400, a velocity vector for PDA 400 is determined. Current velocity vector and current location information for PDA 400 are then compared with velocity vector and location information for other consenting mobile clients. Depending on processing capabilities of PDA 400, comparisons of the velocity and location information can be performed by a process stored in one of the mobile clients, such as PDA 400, or by a process stored in a network connected processing system, such as data processing system 200 in FIG. 2. A common convergence location is selected based on the present velocities and locations of the various consenting mobile clients. The convergence location is selected so that each consenting mobile client will arrive at the convergence location at roughly the same time. For example, if mobile client 1 has a larger velocity vector than mobile client 2, the convergence location will be selected that is closer to mobile client 2's current location and farther away from mobile client 1's location because mobile client 1 will travel a farther distance in a similar time period.

PDA 400 then determines a unique navigational convergence route to the common convergence location. Depending upon the processing capabilities of the various GPS enabled devices, the unique navigational convergence routes can be separately determined and calculated by a process in each mobile client, such as PDA 400.

Alternatively, a mobile client can receive the unique convergence route by communication from the data processing system 200 in FIG. 2 and calculated by a process therein. Each convergence route is a series of navigational and location directions provided to and specific to the mobile client. The unique convergence route is the directional information which each mobile client should follow to reach the convergence location. The unique convergence routes can be as simple as the shortest navigable distance from a mobile client's present location to the convergence location. Alternatively, a unique convergence route can account for speed limits, road conditions, traffic conditions, and other factors that may affect travel time.

PDA 400 and other consenting mobile clients continue to provide real-time location updates to a process in data processing system 200 during travel time. Present velocity vector and present location information are continuously updated. A change in the navigational information including the present velocity vector of one or more of PDA 400 or other consenting mobile clients causes an adjusted convergence location to be calculated. The adjusted convergence location is then communicated to each mobile client, and the unique convergence route is accordingly adjusted.

Additionally, PDA 400 can be provided with information in addition to current locations and convergence locations for each client. PDA 400 can also receive updated remaining distances to the convergence location for each mobile client, as well the estimated arrival time at the convergence location for each mobile client.

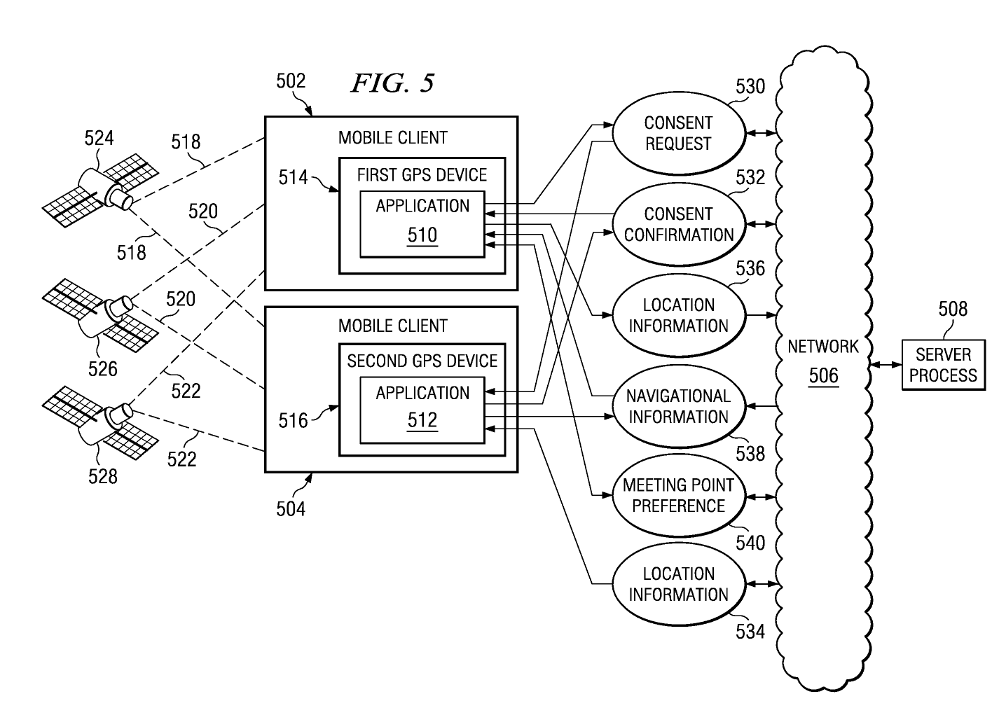

FIG. 5 is a block diagram illustrating a dataflow when a consent request and convergence event is performed in accordance with an illustrative embodiment.

Mobile clients 502, 504 are a client such as client 108 in FIG. 1. Mobile clients 502, 504 may be a cellular telephone, PDA, laptop computer, or other mobile device that can display a map and be able to update information to a user. Mobile clients 502, 504 include a screen that can be used to communicate textual and graphical information the user. Mobile clients 502, 504 also preferably include an input device, such as a touch screen, keyboard, mouse, or other known device that allows the user to input information into the device. Mobile clients 502, 504 can either be integral with the GPS device, or able to communicate with an associated GPS device. The mobile client may be PDA 400 in FIG. 4.

Network 506 is a network of two or more computing devices connected to form a network. Network 506 is any type of network, including but not limited to, a wide area network, a local area network, the Internet, an Intranet, an Ethernet, or any combination of network types. For example, network 506 may include a network such as network 102 in FIG. 1. In this example, network 506 is the Internet.

The network 506 may further include one or more wireless access points for providing access to the network. A wireless access point can be a router that is able to receive and transmit wireless and/or wired signals, or any other device that provides wireless access to a network. Wireless access point may communicate with a GPS device using one of a number of wireless communication protocols, such as Wi-Fi or Bluetooth.

A server running server process 508 can be any computer system, such as data processing system 200 of FIG. 2, with access to network 506.

In the illustrative examples, mobile clients 502, 504 are provided with applications 510 and 512 running in an associated GPS device C. Applications 510 and 512 communicate with a satellite navigation system to determine real time GPS location information of that GPS device 514 and 516. Applications 510 and 512 may receive digital radio signals 518, 520, and 522 or other signals transmitted by GPS satellites 524, 526, and 528. The signals may include the satellite's location and the exact time. Applications 510 and 512 then calculate longitude and latitude of the GPS device 514 and 516 by receiving the signals from GPS satellites 524, 526, and 528, and determining a respective delay from a time each signal is transmitted to a time each respective signal is received by application 510, 512.

Application 510 transmits consent request 530 that is received by the network 506. Consent request 530 can be transmitted using any of various system protocols suitable for providing wireless communication, such as, without limitation, GSM (Group Special Mobile), GPRS (General Packet Radio System), IS-95 CDMA (Code Division Multiple Access), CDMA 2000, integrated digital enhanced network (IDEN), 2.5G or EDGE, and 3G or W-CDMA (Wideband CDMA) (UMTS). The consent request 530 includes the identity of at least one other GPS device 516 with whom the GPS device 514 is attempting to meet. The application 510 then begins to poll for a consent confirmation event 532.

Network 506 forwards the consent request through a network to server process 508 of a data processing system, such as data processing system 200 of FIG. 2. Server process 508 can contain data tables or look up functionalities which include the identities of registered users, including both mobile clients 502, 504 and the associated GPS devices 514, 516. Identities stored within the data tables can include unique address identifiers, such as SIM cards, for each mobile client contained in the data table.

Server process 508 can additionally act as an authentication or log-in server, limiting access to the convergence software to those mobile clients 502, 504 included in the data tables.

Server process 508 then forwards, according to the identity of the mobile client 504, the consent request 530 back through the network 506 to application 512 of GPS device 516. A wireless access point (not shown) communicating the consent request to GPS device 516 is not necessarily the same access point that received the consent request from GPS device 514.

Upon receiving a consent request 530, application 512 prompts the user for a consent confirmation event 532. The consent confirmation event 532 can be any indication of acceptance of the consent request 530. In the event that the user accepts the consent request 530, application 512 transmits the consent confirmation event 532 back through the network to server process 508. Application 512 also begins real time transmission of location information 534 for GPS device 516 to server process 508 of the data processing system.

Server process 508 of the data processing system then forwards consent confirmation event 532 back through the network to application 510 in GPS device 514. Upon receiving consent confirmation event 532, application 510 in GPS device 514 begins real time transmission of location information 536 to process 508.

Location information 534 and 536 are forwarded from applications 510 and 512 back through network 506 to server process 508 of a data processing system. Location information can be updated periodically or continuously by receipt of updated location information from applications 510 and 512.

Responsive to receipt and continuous update of location information 534 and 536 from applications 510 and 512, server process 508 of data processing system determines navigational information 538, including a convergence time and convergence location at which a consenting mobile client 502, 504 will converge with other consenting mobile clients also being monitored.

By continuously receiving real-time location updates from applications 510 and 512, server process 508 in the data processing system determines a velocity vector (not shown) for each consenting mobile client 502, 504. Current velocity vector and current location information received from application 510 is compared with current velocity vector and current location information from application 512. Server process 508 calculates a common convergence location based on the present velocities vectors and locations of the various consenting mobile clients 502, 504. The convergence location is an approximated location where disparate mobile clients will converge if the velocity vectors of each mobile client remain constant. The convergence location is selected so that each consenting mobile client will arrive at the convergence location at roughly the same time. A unique convergence route to the convergence location may also be determined for each of the consenting mobile clients. The unique convergence route is a series of navigational or directional information which a consenting mobile client should follow to reach the convergence location. The unique convergence routes can be as simple as the shortest navigable distance from a mobile client's present location to the convergence location. Alternatively, a unique convergence route can account for speed limits, road conditions, traffic load, and other factors that may affect travel time.

Navigational information 538, including the common convergence location, and optionally the present velocity vectors and locations of each consenting mobile client 502, 504 is communicated back through the network to applications 510 and 512. The unique convergence route may also be included in the navigational information. The navigational information, including the convergence location is communicated to at least one of mobile clients 502, 504. In other words, only mobile client 502 may receive the convergence location. In other cases, mobile client 504 may receive the convergence location. Still further both mobile clients 502, 504 may receive the convergence location.

Server process 508 may also select a meeting point preference from a list of known locations proximate to the common convergence location, to be included in the navigational information 538. The meeting point preference can take into account user preferences of preferred meeting points, like a shop, mall, gas station, as well as other indoor and outdoor locations. Further, if one or more users of mobile clients 502, 504 are in a car, the meeting point preference should be accessible by road. Thus the meeting point preference can take into account the various modes of travel of each mobile client 502 and 504.

Alternatively, a user selected meeting point preference 540 can be selected from a listing of restaurants, coffee houses, intersections, or other locations that are proximate to the calculated convergence location. The meeting point preference 540 can also be manually entered from any of mobile clients 502 and 504.

Depending on the origin of the meeting point preference, the meeting point preference is communicated to at least one of mobile clients 502 and 504.

Convergence times and locations for each mobile client can be updated and recommunicated to each consenting mobile client when subsequent GPS location information from any of the consenting mobile clients is received at data processing system 200 in FIG. 2.

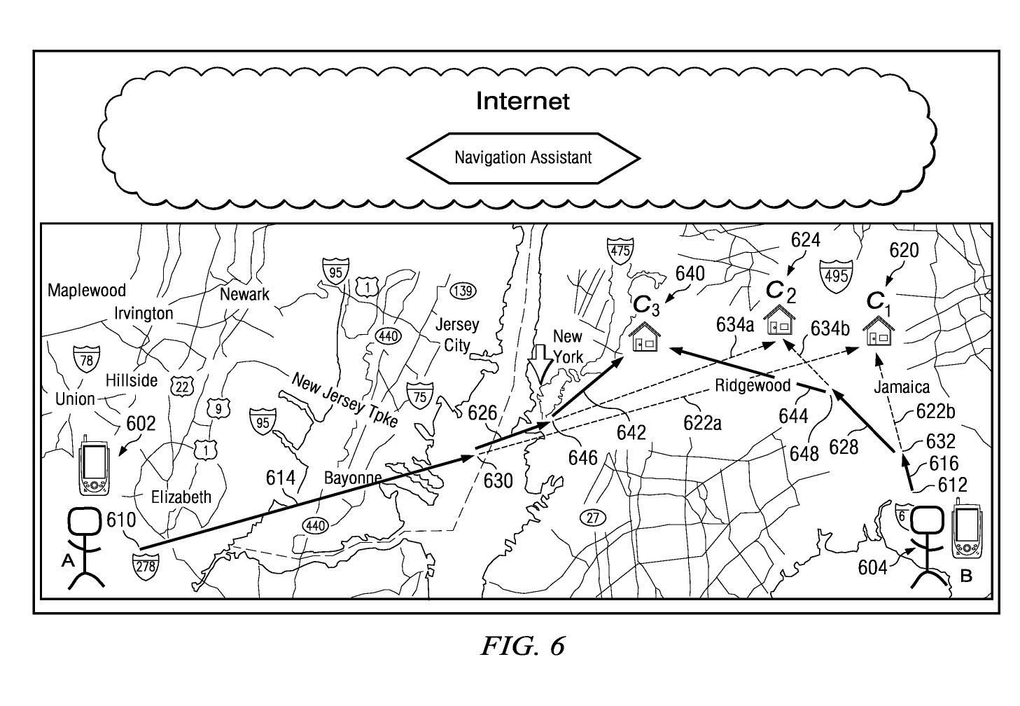

Referring now to FIG. 6, a diagram illustrating an example of the present invention is shown where two users, A 602 and B 604, are dynamically directed to a destination convergence location. A 602 and B 604 are interested in meeting at a central location. A 602 and B 604 both get into separate cars and begin to drive towards one another. B 604 encounters heavy traffic, while A 602 does not. First locations L_{A1} 610, L_{B1} 612 and first velocities V_{A1} 614 and V_{B1} 616 for each of A 602 and B 604 are determined by the data processing system. Based on the present locations L_{A1} 610 and L_{B1} 612 and velocities V_{A1} 614 and V_{B1} 616 of both A 602 and B 604, data processing system selects C₁ 620 as a first convergence location. Because A 602 is traveling faster than B 604, the system selects C₁ 620 at a point closer to B 604. C₁ 620 is chosen by data processing system 200 so as to be “equal time” away from both A 602 and B 604. Server process 508 of FIG. 5 communicates the convergence location C₁ 620, as well as a unique convergence path 622a, 622b to each of A 602 and B 604.

If either A's initial velocity V_{A1} 614 or B's initial velocity V_{B1} 616 changes, for example due to a decrease in traffic, data processing system 200 calculates a new convergence location, C₂ 624 based on the new present velocities V_{A2} 626, V_{B2} 628 and locations L_{A2} 630, L_{B2} 632 of both A 602 and B 604. Data processing system communicates the updated convergence location C₂ 624, as well an updated unique convergence path 634a, 634b to each of A and B.

A third convergence location C₃ 640, based on the third velocities V_{A3} 642, V_{B3} 644 and locations L_{A3} 646, L_{B3} 648 of both A 602 and B 604 is also shown. Data processing system communicates the third convergence location C₃ 640 to each of A and B in response to an additional change in either of V_{A2} 626 or V_{B2} 628.

Neither A 602 nor B 604 need to have any knowledge of their own present location, the location of the other party, or the location of the convergence location. The data processing system continually provides updated optimal convergence locations and route information to each of A 602 and B 604 based on continuously monitored location information provided by A 602 and B 604. Furthermore, the invention can easily be expanded to provide routing information and convergence locations for additional parties.

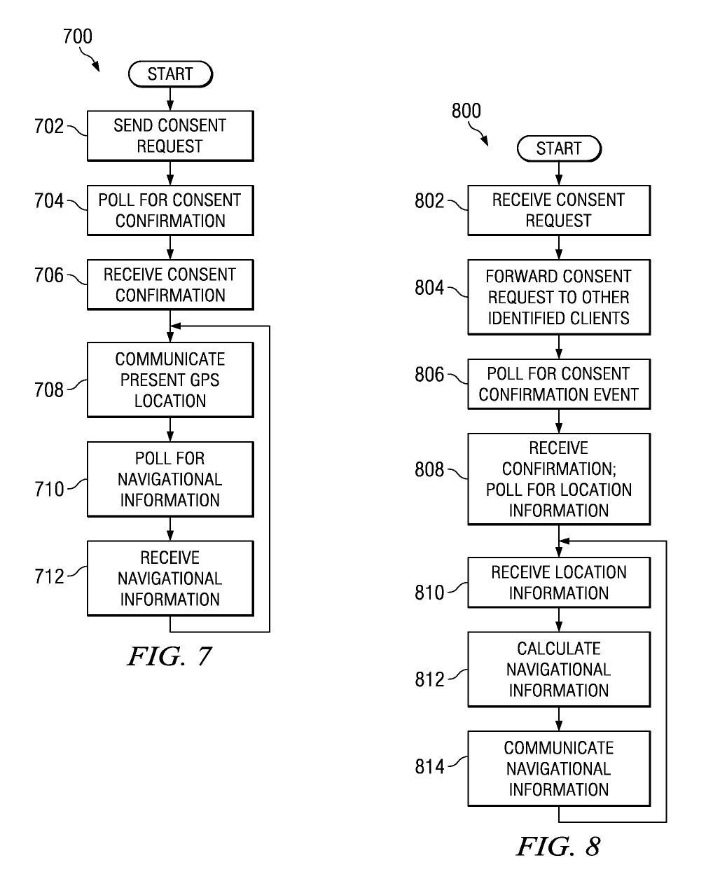

FIG. 7 is a flowchart of the processing performed by a GPS device of a mobile client in an illustrative embodiment. The process illustrated in FIG. 7 may be implemented in a client process such as applications 510 and 512 of FIG. 5.

The process 700 communicates a wireless consent request, such as consent request 530 in FIG. 5, to the network (step 702). The process 700 then proceeds to poll for a consent confirmation event, such as consent confirmation event 532 in FIG. 5 (step 704). The consent request can include the identity of one or more other clients to whom the request is forwarded as well as the identity of the first mobile client.

Wireless access point forwards the consent request through a network, such as network 102 in FIG. 1, to a data processing system, such as data processing system 200 in FIG. 2. According to the identity of the other clients, the data processing system communicates the consent request back through the network to a second GPS device, such as GPS device 516 of FIG. 5. Upon accepting the consent request, a confirmation event is similarly communicated back to the process. In the depicted example, the consent confirmation is a notification of acceptance of the consent request by another GPS enabled device.

Upon receiving confirmation of consent (Step 706) to the server, the process 700 communicates a current location (Step 708) of the GPS device to the data processing system. The process 700 then begins to poll for receipt of navigational information (Step 710). The navigational information can consist of location information for other consenting mobile clients, a common convergence location for the consenting mobile clients, and depending on processing capabilities of mobile client, a unique convergence route for the GPS device.

Based on a series of submitted GPS locations for each consenting mobile client, the data processing system determines navigational information, such as navigational information 538 of FIG. 5, including a convergence time and convergence location at which the communicating mobile client will converge with other consenting mobile clients also being monitored. Navigational information is communicated back through the network to the GPS device and received by the process.

Upon receipt of the navigational information (Step 712), the process 700 calculates a unique convergence route if not provided in the return communication, and displays navigational and directional information on a screen such as screen 302 of FIG. 3. Navigational and directional information can include any of an area map, current locations for one or more mobile clients, velocity for one or more mobile clients, estimated arrival times for one or more mobile clients, as well as the convergence location and optionally, the unique convergence routes for one or mobile clients. The process 700 then proceeds to communicate a new present GPS location (Step 708). The above described process is repeated with the new present GPS location and updated navigational and directional information is provided for display by the process.

FIG. 8 is a flowchart of the processing performed by a central data processing system according to a preferred embodiment of the invention. The process 800 illustrated in FIG. 8 may be implemented in a data processing system, such as data processing system 200 in FIG. 2. The process can be a process such as server process 508 in FIG. 5.

Process 800, stored in a data processing system, receives a consent request (Step 802) from a first client, such as PDA 400. The request can includes the identity of one or more other clients to whom the request is to be forwarded as well as the identity of the first mobile client. The process 800 can contain data tables or look up functionalities which include the identities of registered users, including GPS devices, such as GPS devices 514 and 516 of FIG. 5. Identities stored within the data tables can include unique address identifiers, such as SIM cards, for each GPS device contained in the data table.

Based on the identities of each client provided in the request, process 800 determines the corresponding unique address identifier, and forwards the consent request to each of the other identified clients (step 804). The process 800 then begins polling (Step 806) for consent confirmation event, such as consent confirmation event 532 in FIG. 5, communicated from each of the other clients.

According to the identity of the clients in the consent request, process 800 forwards the consent request through the network and a wireless access point to identified GPS devices, such as GPS device 516 in FIG. 5. Upon accepting the consent request, a confirmation event, such as confirmation event 532 in FIG. 5 is similarly communicated back to GPS device, such as GPS device 514 in FIG. 5. In the depicted example, the consent confirmation is a notification of acceptance of the consent request by another GPS enabled device.

Upon receipt of consent confirmation from one or more consenting mobile clients, process 800 begins polling (Step 808) for a present GPS location information, such as location information 534 and 536 of FIG. 5, from each of the consenting mobile clients.

Location information is similarly communicated from each consenting mobile client back to the data processing system. A time stamp may be associated with each GPS location information upon receipt by process 800 for aiding calculation of velocity vectors. Alternatively, GPS location information may be submitted at predetermined intervals, such that an elapsed time between polling is predefined by process 800.

Responsive to receipt and continuous update of location information from the mobile clients' GPS devices (Step 810), process 800 determines a convergence time and convergence location at which the communicating mobile client will converge with other consenting mobile clients also being monitored. Process 800 compares present GPS locations for each client with any previously submitted GPS locations to calculate navigational and directional information for each consenting mobile client (Step 812), including a calculated convergence location, a unique convergence route, and an estimated arrival time.

Process 800 then communicates at least that navigational information (Step 814) to each consenting mobile client that corresponds to a specific set of navigational and directional information for that mobile client. Convergence information for other clients may also be submitted in order to view real time locations and specific route information of other clients. Additionally, the process may suggest several selectable meeting locations, such as coffee houses, restaurants, clubs, intersections, or other recognizable physical locations proximate to the calculated convergence location for user selection as a selected convergence location.

After communicating routing information to the client at step 814, process 800 returns to step 810 and receives updated GPS location information from each client. Upon receipt of updated GPS location information from the client, the above described process can be repeated with the new present GPS location. Process 800 can then provide updated routing information to each client.

As described, the present invention provides systems and methods for continually tracking the potentially changing location of a plurality of GPS-enabled mobile client devices such as a cellular phones or Personal Digital Assistants (PDAs). The system uses device generated GPS location updates to determine the location and velocity of each device. The system then provides a separate optimal navigation convergence route to each device. Additionally, target locations and ETA indicators can be provided. The system is also capable of determining a common destination or meeting point based on the separate convergence routes. The common destination can be selected by one user from a system maintained listing of locations nearby to the common destination, or the common destination can be automatically determined by the system. The system is capable of providing convergence route and common destination information even when users of the GPS devices are unaware of their present location or the location of the common destination.

Thus, the different illustrative embodiments provide a computer implemented method, apparatus, and computer usable program code for identifying a common meeting point for a plurality of mobile devices. Present locations and velocities are obtained for a plurality of GPS enabled devices. A meeting point destination is selected based on the locations and velocities. The meeting point is then communicated to each of the GPS enabled devices.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for identifying a convergence location for a plurality of mobile clients, the method comprising:
obtaining a first location and a first velocity vector from a first mobile client;
obtaining a second location and a second velocity vector from a second mobile client;
identifying the convergence location based on the first location, the first velocity vector, the second location, and the second velocity vector; and
communicating the convergence location to at least one of the first mobile client and the second mobile client

2. The method of claim 1, wherein the identifying is based on the first location, the second location, the first velocity vector, and the second velocity vector.

3. The method of claim 1, wherein the second mobile client obtains the first location and the first velocity vector from the first mobile client.

4. The method of claim 1, wherein a data processing system obtains the first location, the second location, the first velocity vector, and the second velocity vector.

5. The method of claim 4, wherein the determining step is performed by the data processing system and the data processing system communicates the convergence location to both the first mobile client and the second mobile client via a wireless communication.

6. The method of claim 1 further comprising:
communicating a meeting request to the first global mobile client; and
in response to communicating the meeting request, receiving a response from the first mobile client, wherein the response includes the first location and the first velocity vector if the response is an acceptance of the meeting request.

7. The method of claim 1 further comprising:
obtaining a third location and a third velocity vector from a third mobile client;
identifying the convergence location based on the first location, the first velocity vector, second location, the second velocity vector, the third location and the third velocity vector; and
communicating the convergence location to at least one of the first mobile client, the second mobile client, and the third mobile client.

8. The method of claim 1 further comprising:
identifying a meeting point preference and communicating the meeting point preference to at least one of the first mobile client and the second mobile client, wherein identifying the convergence location is further based on the meeting point preference.

9. The method of claim 8 wherein the meeting point preference is accessible to each of the first mobile client and the second mobile client based on a corresponding mode of transportation for each of the first mobile client and the second mobile client.

10. A computer program product in storage type medium for determining a convergence location for a plurality of mobile clients, the computer program product comprising:
first instructions for obtaining a first location and a first velocity vector from a first mobile client;
second instructions for obtaining a second location and a second velocity vector from a second mobile client;
third instructions for identifying the convergence location based on the first location, the first velocity vector, the second location, and the second velocity vector; and
fourth instructions for communicating the convergence location to at least one of the first mobile client and the second mobile client.

11. The computer program product of claim 10, wherein the identifying step is based on the first location, the second location, the first velocity vector, and the second velocity vector.

12. The computer program product of claim 10, wherein the second mobile client identifies the first location and the first velocity vector from the first mobile client.

13. The computer program product of claim 10, wherein a server obtains the first location, the second location, the first velocity vector, and the second velocity vector.

14. The computer program product of claim 10, wherein the identifying step is performed by the server and the server communicates the convergence location to both the first mobile client and the second mobile client via a wireless communication.

15. The computer program product of claim 10, further comprising:
fifth instructions for communicating a meeting request to the first mobile client; and
sixth instructions for receiving a response from the first mobile client, wherein the response includes the first location and the first velocity vector if the response is an acceptance of the meeting request.

16. The computer program product of claim 10, further comprising:
obtaining a third location and a third velocity vector from a third mobile client;
determining the convergence location based on the first location, the first velocity vector, second location, the second velocity vector, the third location and the third velocity vector; and
communicating convergence location to at least one of the first mobile client, the second mobile client, and the third mobile client.

17. The computer program product of claim 10 further comprising:
fifth instructions for determining a meeting point preference and communicating the meeting point preference to at least one of the first mobile client and the second mobile client, wherein the convergence location is further based on the meeting point preference.

18. The computer program product of claim 17 wherein the meeting point preference is accessible to each of the first mobile client and the second mobile client based on a corresponding mode of transportation for each of the first mobile client and the second mobile client.

19. A data processing system comprising:
a memory that contains a set of instructions;
a processing unit, responsive to execution of the set of instructions, obtaining a first location and a first velocity vector from a first mobile client, obtaining a second location and a second velocity vector from a second mobile client, determining the common meeting point destination based on the first location, the first velocity vector, the second location, and the second velocity vector; and
communicating the common meeting point destination to at least one of the first mobile client and the second mobile client.

20. The data processing system of claim 19, wherein the determining step is performed by the server and the server communicates the common meeting point destination to both the first mobile client and the mobile client device via a wireless communication.
